(19) United States
(12) Patent Application Publication
(10) Pub. No.: US 2015/0350148 A1
(43) Pub. Date: Dec. 3, 2015

(54) HEALTHCARE SECURE MESSAGING AND REMINDER SYSTEM

(71) Applicant: pMDsoft, Inc., San Francisco, CA (US)

(72) Inventors: Adam Russell Kenney, Tampa, FL (US); Siavosh Bahrami, San Francisco, CA (US); Philippe Michel d'Offay, Ross, CA (US)

(21) Appl. No.: 14/644,069

(22) Filed: Mar. 10, 2015

Related U.S. Application Data
(60) Provisional application No. 62/006,639, filed on Jun. 2, 2014.

(51) Int. Cl. H04L 12/58

(52) U.S. Cl. CPC H04L 51/24; H04L 51/12

(57) ABSTRACT

A system provides secure messaging of healthcare data and prompts message responses using prioritized hierarchical reminders. Messages can be sent and received through an application executing on a mobile device or on a web browser or application executing on any computer. The system can provide message notifications and multiple reminders to ensure that a user is reliably receiving and also reading messages. If an in-application message is not read within a time period, the message can followed by a reminder message informing the recipient that there is a secure message waiting. The reminder message can be sent using an application notification or through other channels, such as by SMS text message, automated voice telephone call, or e-mail, without including sensitive patient healthcare information.

### RELATED APPLICATIONS

This application claims the benefit of U.S. Provisional Application No. 62/006,639, filed on Jun. 2, 2014, which is hereby incorporated by reference.

### BACKGROUND

Health care providers deal with critical patients every day, so the ability to exchange information instantly and securely is valuable. Known methods of communication are often unencrypted including SMS text messaging or email, for example. Although convenient and unobtrusive, these forms of messaging are not secure and can expose sensitive patient health information, creating liabilities for the providers and their practices. Heightened HIPAA regulations prohibit the use of SMS text messaging or email to exchange sensitive patient healthcare information.

### SUMMARY

A system provides secure messaging of healthcare data and prompts message responses using prioritized hierarchical reminders. The system can be integrated with mobile device-based point of care systems used by physicians, such as charge capture and coding systems. Messages can be sent and received through an application executing on a mobile device, such as a mobile device based charge capture application, for example, or on a web browser or application executing on any computer. The system can provide message notifications and multiple reminders to ensure that a user is reliably receiving and also reading messages. If an in-application message is not read within a time period, the message can followed by a reminder message informing the recipient that there is a secure message waiting. The reminder message can be sent using an application notification or through other channels, such as by SMS text message, automated voice telephone call, or e-mail, without including sensitive patient healthcare information. The messaging system improves workflow by reducing inefficiencies that result from using separate systems for secure communication and by eliminating a need for an external messaging program involving a user having to log into multiple software programs each day. The messaging system makes communication between doctors easy and accurate, improving continuity in patient care and supports secure interaction with data and applications via the Internet. The messaging system's integration with a mobile charge capture application allows physicians to enter their medical billing charges and patient handoff notes into their computers, smartphones or other mobile devices.

### BRIEF DESCRIPTION OF THE DRAWINGS

FIG. 1 shows a system for secure healthcare messaging and reminder management including secure communication channels in accordance with one embodiment.

FIG. 2 illustrates an example of how multiple reminder messages can be cascaded to a non-responsive user using various insecure communication channels.

FIG. 3 shows a functional diagram of an app operating on a mobile device in accordance with one embodiment.

FIG. 4 is a block diagram of a general purpose computer with computer programs providing instructions to be executed by a processor in the general purpose computer.

### DETAILED DESCRIPTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices, components, and methods to those described herein. In other instances, well-known devices, components, and methods have not been described in detail so as not to unnecessarily obscure aspects of the present invention.

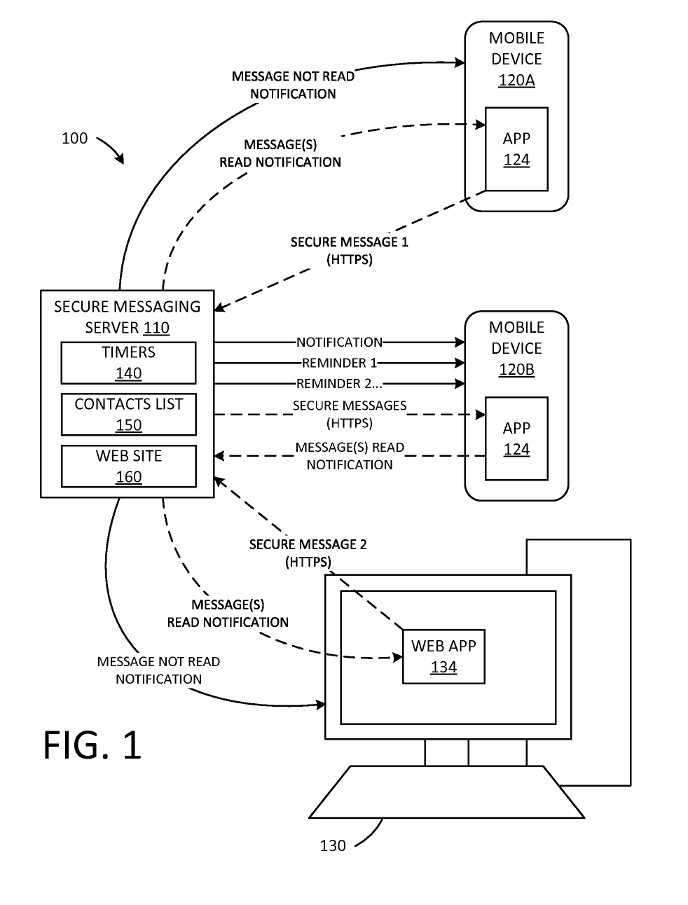

FIG. 1 shows a system 100 for secure healthcare messaging and reminder management including secure communication channels in accordance with one embodiment. Instances of an app 124 running on mobile devices 120A and 120B exchange messages securely using HTTPS over Internet connections through a secure messaging server 110. A medical professional user of a mobile device 120A or of a computer 130, for example, can transmit a secure message to another medical professional user of a mobile device 120B. In one embodiment, a special purpose app 124 executes on the mobile devices 120 to provide a secure interface for sending, receiving and accessing secure communications. A web app 134 operating within a web browser or an executable application executing on a desktop computer 130 or any other type of computer, such as a tablet or notebook computer, can also be used to send, receive and access secure communications. In one embodiment, the messages are presented in the app 124 in a format similar to a text messaging interface on mobile phones. As used herein a reference to the app 124 shall be understood to include a reference to either the app 124, a web app 134 or an executable secure messaging application operating on a computer.

In accordance with one embodiment, user access to the app 124 is secured by an authentication feature, such as a password or biometric identification (e.g. fingerprint scan). The secured access to the app can be added as a second layer of security addition to any primary security features that the mobile device or computer may have in place for limiting access to the devices generally.

In one embodiment, a user of the app 124 specifies the destination address or audience of a secure message. The destination address can be, for example, a medical professional, a group of professionals (e.g. a clinic), or any individuals that have subscribed to messages relating to a particular patient or group of patients. The message can be a text message and can additionally include multimedia content, such as images (e.g. patient x-rays) or other content.

Once a message is composed and addressed, and a user provides an instruction to send the message, the app 124 opens up a secure connection to the secure messaging server 110 and securely transmits the message to the server 110. In one embodiment, the secure connection is established using HTTPS, but other secure communication techniques can be used. The app 124 or the mobile device 120 can include a coding unit, module or application to provide secure communications.

In response to receiving the transmitted message, the secure messaging server 110 identifies devices associated with the destination addresses or audience and securely retransmits the message to instances of the app 124 running on the identified devices. In one embodiment, the secure connection is established using HTTPS, but other secure communication techniques can be used. The server 110 can include a coding unit, module or application to provide secure communications. In addition to securely transmitting the message to the receiving devices, the secure messaging server also transmits a message notification over an insecure channel to indicate to the intended recipients or audience that there is a secure message waiting to be read in the app 124. In one embodiment, the notification indicates to the recipient that there are one or possibly more secure messages awaiting and the notification preferably does not contain any sensitive patient data or confidential information to avoid concerns of transmission over an insecure channel. The notification message can be, for example, an e-mail, an SMS text message, an automated phone call, an Apple iOS push app notification, an Android app notification, or any similar notification that provides a user an indication of a waiting message on the app 124.

In one embodiment, in addition to sending the secure message and notification, the server 110 also sets a timer that counts down a predetermined amount of time after a secure message is sent before a follow up reminder is sent. On the receiving device 120B, the app 124 waits for a user to read each secure message and as messages are read or periodically, the app 124 transmits notifications back to the server 110 identifying each secure message that has been read. A determination that a message has been read can be made, for example, based on identifying whether the message has been opened, replied to or selected by a user on a screen e.g. via a cursor. For example, a user can click on a message within the web app 134 using a mouse on the computer 130 or tap on the message within the app 124 on the mobile device 120 to mark all messages in a conversation as read. In one embodiment, a camera on the mobile device can be used to monitor the eyes of a user to determine whether the user's eyes have scanned a message displayed on the screen of the mobile device and thereby determine that a message has been read. The “message read” indications can be sent over a secure channel or over an insecure channel by the app 124. Where messages are time-sensitive and critical for example, in the care of hospitalized patients with acute medical issues, clinicians working in the hospital environment may not receive or may not notice an initial notification about a message, so follow-up reminders are advantageously helpful in prompting reading of an unread message and improving patient healthcare.

By receiving “message read” indications from instances of the app 124 executing on mobile devices 120, the server 110 can keep track of which users have read which secure messages and can then send reminders to users to read unread messages as countdown timers 140 expire. The duration of the countdown timers 140 can be set, for example, on a system-wide level, on a user-configurable level, or based on group policies, such as for a clinic of users.

In one embodiment, as the server 110 receives “message read” indications, it passes these indications on to the sending users' mobile devices so that the senders can monitor which sent messages have been read by their intended recipients. The indications of messages having been read can be displayed within the app 124 user interface in association with or as a feature of a display of each sent message.

In one embodiment, if a predetermined amount of time passes without the server 110 having received an indication that a message has been read, the server 110 transmits a notification to the sending user's device 120A indicating that a message has not been read. This notification and optional reminders back to the sender can be sent as insecure notifications in a manner similar to the initial notification and reminders to the recipient. Accordingly, if a message is not read by the intended recipient(s), the sender can find some other way to contact the recipient or attempt to message someone else who may be able to act.

In accordance with one embodiment, multiple reminders to a user can be combined into a single reminder. If a user has multiple unread messages, a single reminder can be sent to the user indicating the number of unread messages that are waiting for the user's attention. In one embodiment, the message transmission, notification and reminder functionality and features are included in a message processor module operating on the secure messaging server 110. The timers 140 can also be implemented within or as part of the message processor module. The message processor can be coupled to the coding unit on the server 110.

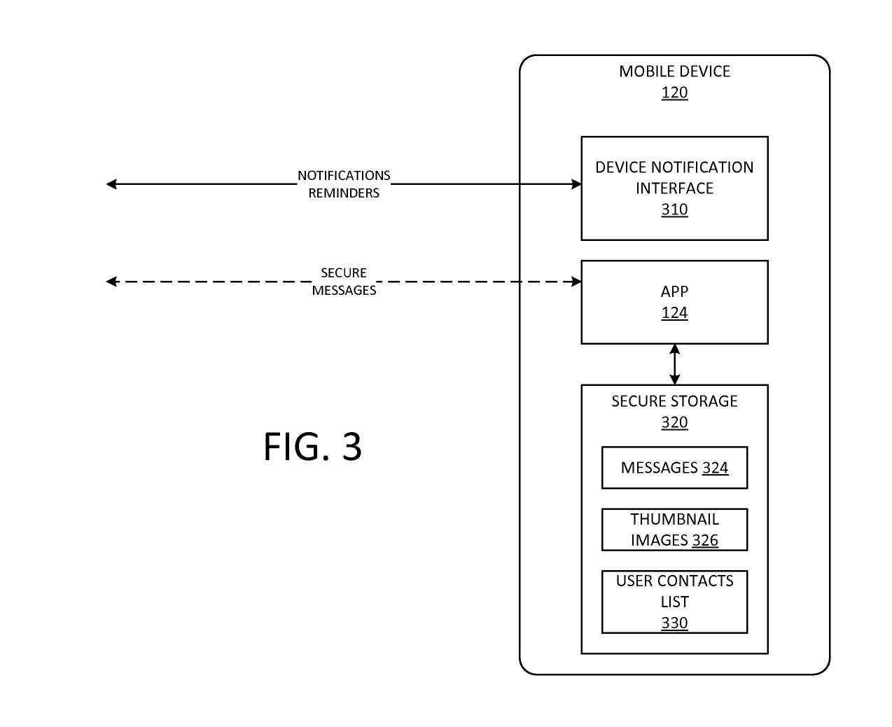

In accordance with one embodiment, the server 110 maintains a system contacts list 150 including contact information and optionally device information for users of the system 100. In accordance with one embodiment, each user can maintain a user contacts list 330 (FIG. 3) that is user-specific subset of the users in the system contacts list 150. A local copy of the user contacts list 330 can be cached on each of a user's devices.

In accordance with one embodiment, the app 124 provides a user interface enabling a user to view and organize a list of their active conversations (e.g. from most recent to least recent). The user can send someone a message either by opening an active conversation and typing into it, or by selecting a “compose” option and searching their contacts list by name. The app 124 can sort the user's contacts list in a useful way, for example, listing people within a user's practice before those outside of the practice, to improve the likelihood that a user will not need to search.

In one embodiment, the server 110 hosts a web site 160. The web site 160 can provide or serve the web app 134 and can provide an interface for accessing secure messaging using a web browser operating on a desktop computer or any user computing device. The web site 160 can also be configured to provide user administration features, such as configuration of a user's account including passwords, devices or other contact information. The web site 160 can also provide an interface through which a user can maintain their contacts list 330.

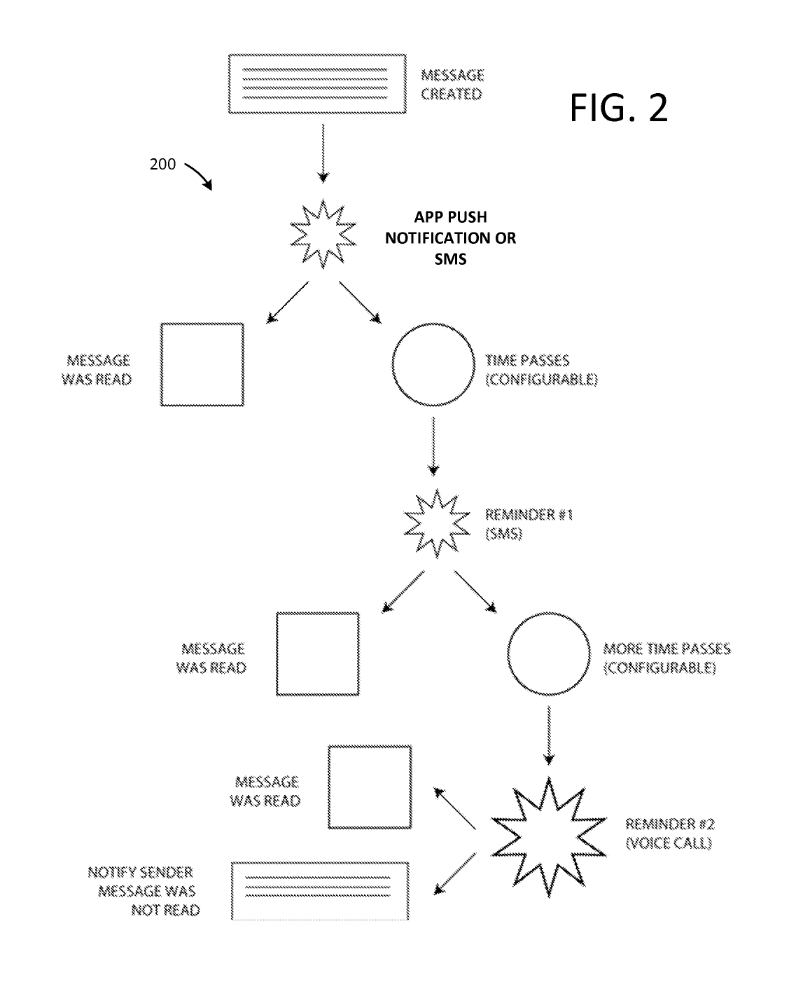

FIG. 2 illustrates an example 200 of how multiple reminder messages can be cascaded to a non-responsive user using various insecure communication channels. In one embodiment, more urgent and direct channels of communication are leveraged as time passes in attempt to more successfully obtain action from the recipient user. Reminders can be sent, for example, using e-mail, an SMS text message, an automated phone call, an Apple iOS push app notification, an Android app notification, or any other notification technique.

In the example 200, a message is created and sent with an initial notification that can be an in-app notification or an SMS message. If the message is read by the user, then no further action is needed, but if a configurable amount of time passes without the server 110 receiving a “read” notification from a device of the user, a follow up reminder #1 is sent to the user by SMS. If the message is then read by the user, no further action is needed, but if a further configurable amount of time passes, the server 110 can initiate an automated voice telephone call to the user as an additional reminder. If the message is then read by the user, no further action is needed, but if a further configurable amount of time passes, the server 110 can then send a message back to the original sender of the message indicating that the intended recipient has not read the message. This message back to the sender can be sent as a secure or an insecure message based on user or system configuration and preferences. If the message back to the sender includes a copy of the original message, then the message back is preferably sent using the secure channel. A notification and reminders can also be set in place for the message back to the original sender to ensure receipt of the indication that the first intended recipient has not read the original message.

In one embodiment, secure message content is sent through cellular data, WiFi or Ethernet and is encrypted. Notification and reminder messages can be communicated in different ways. An initial notification may be sent via Apple and Google's push frameworks or via SMS or via email, for example. A reminder to read a message can be sent via SMS and/or voice call or email, for example. In one embodiment, message urgency level is indicated as low, medium or high priority in notification text and/or by a visual indicator. The system can adaptively select types and sequences of reminder communication messages sent in response to message urgency level. For example, a low priority message may have no unread reminder messages, a high priority message may require an unread reminder notification by both a push message and text. An escalation process can be used if a user does not read a message including escalating through a series of reminders. A first SMS reminder can be sent after configurable period of time, followed by a voice phone call reminder after configurable amount of time and (together and concurrently within one embodiment) an email reminder. If a notification message indicating a message has been read is not received within a configurable amount of time after a voice reminder, a message can be sent to the sender indicating the message still has not been read.

In one embodiment, the system 100 can provide the ability to send a high priority message that has special notification features, such as an audible notification that is louder than audible notifications that may be associated with ordinary notifications that arrive on the user's device 120. Some devices have a vibrate feature to alert users of a notification and a different or more persistent vibration pattern can be used to identify high priority messages. Reminders for the high priority message can also be set on a more urgent schedule using more aggressive contact methods, such as reverting to an automated phone call after a brief period without the user reading the message.

In one embodiment, the system 100 can provide the ability to send a “page” type of message to another users. A page message can be a pre-configured message that can be selected by a sender to indicate to the recipient that they should get in touch with the sender. The page message can include pre-configured contact information for the sender, such as the sender's phone number. The page message can be sent as a high priority message with special notification features as noted above.

In an embodiment, the system can interact with wearable devices, such as smart eyeglasses, smart watches and smart rings, as “notification only” devices. The system provides these devices with notifications, although a user may not be able to use these insecure devices to read secure message content itself. The system can adaptively and intelligently select devices to which to route a particular notification. For example, someone who carries a phone in a bag might configure to be notified of new messages primarily via their smartwatch, but might want to read all messages on their phone or using the web app 134.

FIG. 3 shows a functional diagram of an app 124 operating on a mobile device 120 in accordance with one embodiment. The app 124 preferably executes on the mobile device 120, sending and receiving secure messages over a secure channel in communication with the server 110. The mobile device 120 may also have a device notification interface 310 through which app notifications, such as received e-mails, text messages, missed phone calls or other device or app notifications can be surfaced to the user. The system 100 can use the device notification interface 310 to surface notifications and reminders to the user by sending the notifications and reminders over a non-secured communication channel, such as the Apple iOS app push notification framework (“Apple Push Notification Service”) or the Google Android app push notification framework (“Google Cloud Messaging”).

The app 124 can maintain a secure storage 320 in the memory of the mobile device 120 by encrypting data it saves to the memory. In one embodiment, the app 124 decrypts messages received from the server 110 over the secure communication channel and then re-encrypts the messages for storage in the local secure storage 320. In this manner, the received messages can be decrypted when accessed by the user, but otherwise securely stored on the mobile device 120.

In accordance with one embodiment, users can send attachments in secure messages. Attachments can include, for example, photos (either from an existing gallery, or taking a photo on the fly within the app 124); videos; or other types of files that can be stored on a the mobile device 120 or a computer hard drive or “shared” from another app into the app 124. The attachments can be securely transmitted and securely stored along with the messages in the same manner. In accordance with one embodiment, the system 100 implements a dynamic transfer and storage policy, which establishes file size limits for the mobile app 124 and for the system 100 as a whole. There can be a size limit for automatic app downloads via cellular; a higher size limit for automatic app downloads via WiFi; and a third, even higher size limit for manually downloading an attachment within the app 124. The secure messaging server 110 can implement an overall maximum file size for the system that can be set equal to the size limit for manually downloading an attachment within the app 124.

In accordance with one embodiment, when the app 124 downloads a photo attachment, it creates a small thumbnail image 326, which is stored and encrypted separately from the large photo in the secure storage 320. As the user scrolls rapidly through a conversation, only the thumbnail image 326 need be decrypted for display, which reduces the processing and memory overhead.

A local copy of the user contacts list 330 can be cached in the secure storage 320 in one embodiment. Alternatively, the local cached user contacts list 330 can be stored outside of the secure storage 320 without encryption.

In one embodiment, the messaging system 100 encodes messages such that data from a recipient user (such as a password, fingerprint or retinal scan) is needed in addition to data provided by the messaging system (such as a system key or passcode) in order for the message to be decoded. The user can advantageously decode their own information because they are using the messaging system application employing a user password, fingerprint or retinal scan, for example. In one embodiment, messages are encoded such that messaging system operators are unable to read the messages. In one embodiment, even if the data and system keys are obtained by a third party (e.g. hacker or government entity) they are unreadable. In another embodiment message content data is encoded multiple times using different keys. In one embodiment, the messaging system supports messaging to different types of device, e.g. if a user accesses the messaging system by different devices such as a fingerprint-enabled device (such as an iPhone) or a non-fingerprint-enabled device (such as a PC). In one embodiment, the messaging system tracks the type of devices that a user uses to access the messaging system and encodes a message multiple times, once for each device that a user has registered. In one embodiment, during device registration (i.e. on first startup) a device is interrogated by the messaging system (or the device automatically communicates data) to determine the device type of authorization and login system (i.e. whether it is biometrically, e.g. fingerprint, retina scan, vein scan, enabled).

In one embodiment, messaging system 100 tracks and stores a public key for each device enabling the system to encrypt messages for each device, but not decrypt them. The device itself stores the private key (or it is dynamically regenerated and not stored, e.g. from a fingerprint or a typed-in password) and used with the public key to decrypt a message. The messaging system concurrently sends a message encrypted by device specific methods to multiple different devices. A user may have three mobile devices registered (e.g., iPhone, iPad, iPad Mini) and may also access their messages on the Internet. A user sees the same decoded data irrespective of which device they use to access the system, and devices of a user concurrently receive different types of notification and reminder messages that the device supports. In one embodiment, the system advantageously provides multiple levels of encryption by encrypting a message twice (once with each messaging system public key and again with the device (and/or user) specific public key). Alternatively, the system in an embodiment, encrypts a message one time using a combined key derived by merging the messaging system public key and the device (and/or user) specific public key by a predetermined method to create a single key that is unique to a device/user. In one embodiment, the system 100 generates multiple encrypted versions of a message: one for each destination device that a recipient has registered with the system, and one for each device that a sender has registered with the system. In one embodiment, the system discards the original version of the message and exclusively retains the encrypted versions.

A physician user, for example, may have multiple system accounts, such as an account associated with employment by a hospital, and a different account for private practice involving only their own patients. In one embodiment, the system provides the different account messages into a single inbox. Accounts may be linked together by different identifiers, which may include their NPI # (official provider ID created by the government), cell phone number, email address, and/or a manually created link. A National Provider Identifier or NPI is a unique 10-digit identification number issued to health care providers in the United States by the Centers for Medicare and Medicaid Services (CMS). The NPI # may be used to link multiple accounts of a user to an entry in a list of another user such as a list of referring doctors using the messaging system. This enables a user to know if a referring physician, for example, is a user of the messaging system, and if so, allows a message recipient to send a message to the referring physician automatically without having to manually add the referring physician to a contacts list 330.

In one embodiment, a user can create or edit their user contacts list 330 through the app 124, the web app 134 or the web site 160. The system can automatically interrogate databases and messages to build a user contacts list 330. In operation, the server 110, the app 124 or both can build a contacts list 330 including, for example:

(a) providers in a user's group who are “messaging enabled”

(b) staff and administrators in the user's group who are “messaging enabled”

(c) external providers outside of the user's group who are in the user's list of referring providers (e.g. who have referred patients to the user practice)—the system matches an entry in a referring provider list with a system user account using the NPI #

(d) external staff and administrators outside of the user group who have access to the user group (e.g. 3rd party billing companies, hospital administration, answering service)

(e) people and/or group chats with whom the user has active conversations

(f) additional contacts from a global contacts list for the practice

(g) external providers outside of the user group that are also associated with patients that the user is associated with—even if they are not otherwise part of the user's contacts

(h) communities of users, as described below.

In one embodiment, the system 100 provides the ability to define communities of users where the members of the community are mutually included in each other's user contact lists 330. Groups, organizations, or individuals can opt-in as members of a community and membership can be open, limited or managed by an administrator. For example, a cardiology group can become a member of a hospital's community such that all the members of the cardiology group share contact information with all of the members of the hospital community. In one embodiment, all members of a community can be provided permission to access certain types of basic or minimal patient data that can be maintained in the system.

In one embodiment, a user can maintain a list in the system of healthcare providers that refer patients to the user. The system can automatically extract NPI #s from the list of referring doctors and search the messaging system user base list to identify any referring doctors already in the user base of the messaging system. In response to automatically determined matches, messaging and contact data of identified referring providers can be automatically incorporated in the user contacts list 330 for use in messaging.

In one embodiment, the messaging system supports patient-centric messaging by enabling a user to subscribe to a patient and to automatically receive messages about that patient even though the user is not a designated recipient of a message and not on a sender contacts list 330. In one embodiment, a user needs to be on the sender contacts list 330 to receive messages. In one embodiment, a contact discovery function automatically searches for, and adds contact details of physicians having a care relationship with a patient of a user. The system thereby automatically, 1) enables a user to communicate with people who are absent from the messaging system contacts data but who are part of a care team for a specific patient and 2) adds contact data of people to a user contacts list 330 based on the determination that if a healthcare worker (e.g. physician, nurse, technician) has a shared patient with the user, there is a reasonable likelihood the user may need to send them a secure text message.

For healthcare providers who work closely together, the system may automatically copy someone else into a conversation, turning a message with a single recipient into a group chat. For example, if a doctor works extensively with a physician's assistant, then a message to the doctor may automatically be converted by the system into a group chat that includes the assistant as well.

In one embodiment, the system provides the ability to message a “doctor on-call today” to automatically route a message to one or more recipients based on an on-call schedule that is maintained by a group in the system. This way an external group, such as emergency room doctors, do not have to keep track of which consultant (like a cardiologist or a hospitalist) is on service on a particular day. For example, a user can message the “cardiologist on call” and if the cardiologists maintain their call schedule in the system, the message is routed to the appropriate person(s). In one embodiment, messages can be cascaded among a chain of recipients until the message is read. For example, a message can be first routed to an assistant of a doctor, without the doctor being notified, and if the message is not read by the assistant, the message can be then routed to the doctor.

In accordance with one embodiment, the system enables users to archive individual messages within a conversation, causing them to be hidden from view or appear visually collapsed in an application UI. Archived messages can be configured to be found by a search functionality but otherwise hidden from view. This helps a user maintain a “to do list” of messages that they have not acted on, by archiving messages that they have already dealt with. In accordance with one embodiment, when a user archives a message, the app 124 removes any locally stored attachments from the user's devices.

For compliance purposes, the system can employ a per-organization policy to automatically delete and purge messages where a) recipients have archived a message, and b) a predetermined period amount of time (per-organization setting) has passed since the last archival. The system can implement a retention policy for these text messages and deletes them once the information in them is no longer immediately clinically actionable.

The system can support time based selection and communication of non-urgent notification and reminder messages. Message urgency can be indicated by user selection or for automatically generated messages based on what the message is about. Based on the urgency, the system can select not to wake up people between 9 pm and 7 am, for example.

In accordance with one embodiment, a sending user can send a secure message to another person who is not in the user's contacts list 330 by addressing a message to the person using the person's contact information, such as an e-mail address or phone number. The message can even be addressed while the user's mobile device is without network access and the message will then be transmitted upon the device becoming connected to a network. Upon receiving a message with the person's contact information, the server 110 can check whether the person is a user of the system based on the contact information. If the person is a system user, the server can deliver the message to the user and adds the person to the sending user's contacts list 330. If the person is not a system user, the server 110 can send a non-secure message to the person using the contact information with an invitation for the person to become a user of the system. Once the person registers with the system 100, the server can then transmit the secure message to the person's device 120 and add the person to the sender's contacts list 330.

In accordance with one embodiment, in order for a person to register with the system 100 as a user, the person installs the app 124 on a mobile device, enters, for example, their phone number or e-mail into the app, and awaits a confirmation code sent by, for example SMS or e-mail, to the mobile device from the server 110. The user then enters the confirmation code into the app 124 to verify their ownership of the phone number or e-mail address. The user is then given an opportunity to select a password or other authentication data and to provide contact information. A similar process can be implemented through the web app 134 or the web site.

In accordance with one embodiment, the system 100 provides an application program interface (API) that provides an interface through which an organization, such as a staffed call center, can securely message with users of the system 100. The API can provide to the staff of the call center the ability to directly message system users so that doctors or patients calling the call center can communicate with the system users. In this manner, the API can effectively bridge the secure messaging system 100 with a traditional call center operation. In accordance with one embodiment, the call center can bundle patient information that the call center may have about a patient and send that bundled patient information along with a secure message to a system user recipient. In one embodiment, the system 100 can also maintain patient data for patients being treated by system users. Uses, administrators, or call centers using the API can provide or update patient data maintained by the system 100. When a message relating to a patient is transmitted to a system user, data about the patient that is maintained by the system can be included with the message.

The server 110, mobile devices 120, computers 130, and any other devices accessing the server 110 can be embodied as computers or computer systems in accordance with the description that follows.

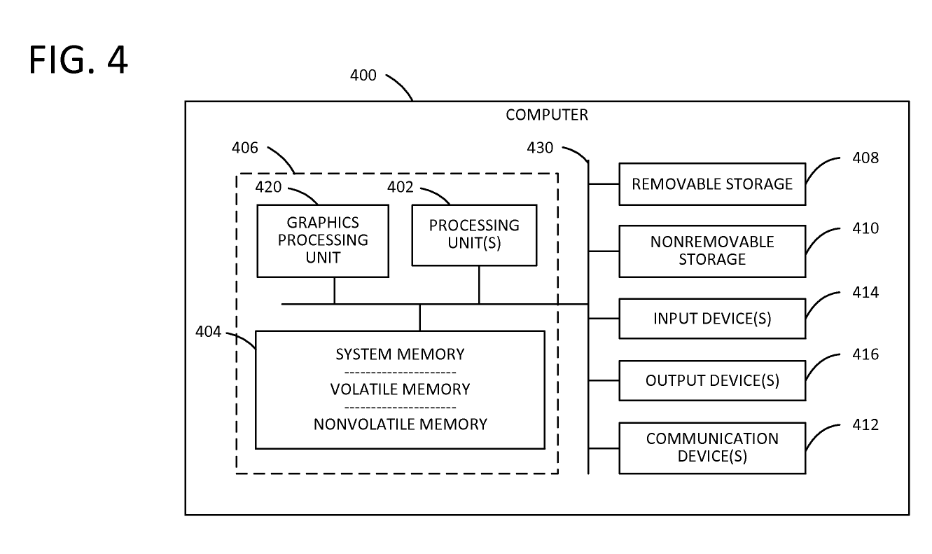

FIG. 4 is a block diagram of a general purpose computer with computer programs providing instructions to be executed by a processor in the general purpose computer. Computer programs on a general purpose computer generally include an operating system and applications. The operating system is a computer program running on the computer that manages access to various resources of the computer by the applications and the operating system. The various resources generally include memory, storage, communication interfaces, input devices and output devices.

Examples of such general purpose computers include, but are not limited to, larger computer systems such as server computers, database computers, desktop computers, laptop and notebook computers, as well as mobile or handheld computing devices, such as a tablet computer, hand held computer, smart phone, media player, personal data assistant, audio and/or video recorder, or wearable computing device.

With reference to FIG. 4, an example computer 400 includes at least one processing unit 402 and memory 404. The computer can have multiple processing units 402 and multiple devices implementing the memory 404. A processing unit 402 can include one or more processing cores (not shown) that operate independently of each other. Additional co-processing units, such as graphics processing unit 420, also can be present in the computer. The memory 404 may include volatile devices (such as dynamic random access memory (DRAM) or other random access memory device), and non-volatile devices (such as a read-only memory, flash memory, and the like) or some combination of the two. This configuration of memory is illustrated in FIG. 4 by dashed line 406. The computer 400 may include additional storage (removable and/or non-removable) including, but not limited to, magnetically-recorded or optically-recorded disks or tape. Such additional storage is illustrated in FIG. 4 by removable storage 408 and non-removable storage 410. The various components in FIG. 4 are generally interconnected by an interconnection mechanism, such as one or more buses 430.

A computer storage medium is any medium in which data can be stored in and retrieved from addressable physical storage locations by the computer. Computer storage media includes volatile and nonvolatile memory devices, and removable and non-removable storage media. Memory 404 and 406, removable storage 408 and non-removable storage 410 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 400 may also include communication device(s) 412 through which the computer communicates with other devices over a communication medium such as a computer network. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals.

Communications device(s) 412 can include, for example, a network interface or radio transmitter, that interface with the communication media to transmit data over and receive data from signals propagated through communication media. The communication device(s) 412 can include one or more radio transmitters for telephonic communications over cellular telephone networks, and/or wireless connections to a computer network. For example, a cellular connection, a WiFi connection, a Bluetooth connection, and other connections may be present in the computer. Such connections support communication with other devices, such as to support voice or data communications.

The computer 400 may have various input device(s) 414 such as a various pointer (whether single pointer or multipointer) devices, such as a mouse, tablet and pen, touchpad and other touch-based input devices, image input devices, such as still and motion cameras, audio input devices, such as a microphone, and various sensors, such as accelerometers, thermometers and the like, and so on. Output device(s) 416 such as a display, speakers, printers, and so on, also may be included. All of these devices are well known in the art and need not be discussed at length here.

The various storage 410, communication device(s) 412, output devices 416 and input devices 414 can be integrated within a housing of the computer, or can be connected through various input/output interface devices on the computer, in which case the reference numbers 410, 412, 414 and 416 can indicate either the interface for connection to a device or the device itself as the case may be.

An operating system of the computer typically includes computer programs, commonly called drivers, that manage access to the various storage 410, communication device(s) 412, output devices 416 and input devices 414. Such access generally includes managing inputs from and outputs to these devices. In the case of communication device(s), the operating system also may include one or more computer programs for implementing communication protocols used to communicate information between computers and devices through the communication device(s) 412.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A system or computer system can include multiple computers or multiple computer systems connected by a computer network.

Each component (which also may be called a “module” or “engine” or the like), of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, the term “based upon” shall include situations in which a factor is taken into account directly and/or indirectly, and possibly in conjunction with other factors, in producing a result or effect. In the claims, a portion shall include greater than none and up to the whole of a thing; encryption of a thing shall include encryption of a portion of the thing. In method claims, any reference characters are used for convenience of description only, and do not indicate a particular order for performing a method.

What is claimed is:

1. A computer system for secure healthcare messaging and reminder management, the computer system comprising:
a communication device for receiving and sending messages;
a coding unit configured to encode messages for secure transmission through the communication device; and
a message processor configured to:
receive a first message securely transmitted from a sending user device by a sending user,
identify a recipient user device of a recipient user based on the received first message,
use the coding unit to securely transmit the first message to the recipient user device,
transmit a first notification to the recipient user indicating that there is a secure message for the recipient user,
monitor for a communication from the recipient user device indicating that the first message has been read,
after expiration of a first timer without having received a communication that the first message has been read, send a first reminder to the recipient user indicating that there is a secure message for the recipient user, and
after expiration of a second timer without having received a communication that the first message has been read, send a second reminder to the recipient user indicating that there is a secure message for the recipient user, wherein the second reminder is of a different type than the first reminder.

2. The computer system of claim 1, wherein one of the first notification, the first reminder and the second reminder causes the recipient device to produce an audible, visual or vibration cue that is different than an audible, visual or vibration cue caused by another of the first notification, the first reminder and the second reminder.

3. The computer system of claim 1, wherein the first notification, the first reminder and the second reminder are each of a type selected from the group consisting of app notification, automated phone call, text message, and e-mail.

4. The computer system of claim 3, wherein at least two of the first notification, the first reminder and the second reminder are each of a different type.

5. The computer system of claim 1, wherein the first notification, the first reminder and the second reminder are each transmitted using a non-secure communication.

6. The computer system of claim 1, wherein the message processor is further configured to:
after expiration of a third timer without having received a communication that the first message has been read, send a notification to the sending user indicating that the first message has not been read.

7. The computer system of claim 1, wherein the message processor is further configured to:
receive a second message transmitted from the sending user device by the sending user, wherein the second message is of a different format than the first message, and
in response to receiving the second message, transmit a second notification to the recipient user device that causes the recipient user device to produce an audible, visual or vibration cue that is different than an audible, visual or vibration cue provided in association with the first notification.

8. The computer system of claim 7, wherein the format of the second message incorporates a request that the recipient user call a phone number of the sending user or a request that the recipient user contact the sending user.

9. The computer system of claim 1, wherein the message processor is further configured to build a contacts list for the sending user by at least:
checking for users with which the sending user has had active conversations;
checking for users in a group associated with the sending user;
checking for users in a global contacts list associated with the group;
checking for users outside of the group that have referred patients to the sending user or checking for users outside of the group that have referred patients to the group;
checking for users outside of the group that have access to the group; and
checking for users outside of the group that have a common patient in association with the sending user.

10. The computer system of claim 9, wherein the message processor is configured to build the contacts list for the sending user by further:
checking for users within communities of users to which the sending user belongs.

11. A method for secure healthcare messaging and reminder management, the method comprising, on a computer system:
receiving a first message securely transmitted from a sending user device by a sending user;
identifying a recipient user device of a recipient user based on the received first message;
securely transmitting the first message to the recipient user device;
transmitting a first notification to the recipient user indicating that there is a secure message for the recipient user;
monitoring for a communication from the recipient user device indicating that the first message has been read;
after expiration of a first timer without having received a communication that the first message has been read, sending a first reminder to the recipient user indicating that there is a secure message for the recipient user; and
after expiration of a second timer without having received a communication that the first message has been read, sending a second reminder to the recipient user indicating that there is a secure message for the recipient user, wherein the second reminder is of a different type than the first reminder.

12. The method of claim 11, wherein one of the first notification, the first reminder and the second reminder causes the recipient device to produce an audible, visual or vibration cue that is different than an audible, visual or vibration cue caused by another of the first notification, the first reminder and the second reminder.

13. The method of claim 11, wherein the first notification, the first reminder and the second reminder are each of a type selected from the group consisting of app notification, automated phone call, text message, and e-mail.

14. The method of claim 13, wherein at least two of the first notification, the first reminder and the second reminder are each of a different type.

15. The method of claim 11, wherein the first notification, the first reminder and the second reminder are each transmitted using a non-secure communication.

16. The method of claim 11, further comprising, on the computer system:
after expiration of a third timer without having received a communication that the first message has been read, sending a notification to the sending user indicating that the first message has not been read.

17. The method of claim 11, further comprising, on the computer system:
receiving a second message transmitted from the sending user device by the sending user, wherein the second message is of a different format than the first message, and
in response to receiving the second message, transmitting a second notification to the recipient user device that causes the recipient user device to produce an audible, visual or vibration cue that is different than an audible, visual or vibration cue provided in association with the first notification.

18. The method of claim 17, wherein the format of the second message incorporates a request that the recipient user call a phone number of the sending user or a request that the recipient user contact the sending user.

19. The method of claim 11, further comprising, on the computer system, building a contacts list for the sending user by at least:
checking for users with which the sending user has had active conversations;
checking for users in a group associated with the sending user;
checking for users in a global contacts list associated with the group;
checking for users outside of the group that have referred patients to the sending user or checking for users outside of the group that have referred patients to the group;
checking for users outside of the group that have access to the group; and
checking for users outside of the group that have a common patient in association with the sending user.

20. The method of claim 19, wherein the building of the contacts list for the sending user is performed by further:
checking for users within communities of users to which the sending user belongs.
